(19) United States
(12) Patent Application Publication
(10) Pub. No.: US 2021/0053807 A1
(43) Pub. Date: Feb. 25, 2021

(54) Flexible In-Ground Lifting System for Lifting a Vehicle and Method Therefor

(71) Applicant: Stertil B.V., Kootstertille (NL)

(72) Inventor: Hains Hoekstra, Kootstertille (NL)

(21) Appl. No.: 16/999,293

(22) Filed: Aug. 21, 2020

(30) Foreign Application Priority Data
Aug. 22, 2019 (NL) 2023689

(51) Int. Cl. B66F 7/20; B66F 7/28; B66F 7/06

(52) U.S. Cl. CPC B66F 7/20; B66F 2700/057; B66F 7/065; B66F 7/28

(57) ABSTRACT

The invention relates to an in-ground lifting system and corresponding methods for lifting a vehicle. The lifting system includes: a pit provided with a pit frame; two or more moveable lifting devices configured for moving in the pit; and a system controller configured for defining at least one set of lifting devices for lifting a vehicle.

### CROSS-REFERENCE TO RELATED APPLICATION

This application claims priority to The Netherlands Patent Application No. 2023689 filed Aug. 22, 2019, the disclosure of which is hereby incorporated by reference in its entirety.

### BACKGROUND OF THE INVENTION

### Field of the Invention

The invention relates to an in-ground lifting system, and more specifically to a system having a number of moveable lifting devices. Such systems are used for lifting trucks, buses, passenger cars and/or other vehicles.

### Description of Related Art

Conventional in-ground lifting systems comprise a stationary lifting device that is positioned in a workshop. In use, an axle is positioned above the stationary lifting device. The lifting system also comprises a moveable lifting device that is then positioned below a further axle of the vehicle. This moveable lifting device is moved in a so-called pit. This enables the lifting system to deal with different wheelbases of the vehicles to be lifted. Usually, a cover is provided to cover the opening of the pit to provide a safe working place. These conventional systems are custom made, thereby resulting in complex and relatively expensive lifting systems.

WO 2015/108414 A1 discloses an in-ground lifting system having a modular structure to enable a flexible pit frame. This provides an effective system for an in-ground lifting system that is more economically feasible.

These conventional lifting systems are capable of lifting vehicles with different axle distances. However, to enable lifting of a relatively large variety of vehicles the pit requires a certain length. This means that such system requires a relatively large space in the workshop, also in case of lifting relatively small vehicles. Therefore, these lifting systems are relatively inefficient in view of their required space.

### SUMMARY OF THE INVENTION

An objective of the present invention is to obviate or at least reduce the aforementioned problems and to provide an in-ground lifting system that is more flexible and is more efficient in its use of the workshop.

This objective is achieved with the in-ground lifting system according to the invention for lifting a vehicle, the lifting system comprising:
a pit provided with a pit frame;
two or more moveable lifting devices configured for moving in the pit; and
a system controller configured for defining at least one set of lifting devices for lifting a vehicle.

The invention relates to so-called in-ground lifting systems having a pit wherein at least two moveable lifting devices are positioned that are capable of moving in the pit. This enables handling different axle distances. The pit extends over a certain length, thereby enabling lifting vehicles in a wide range of vehicle dimensions. Typically, the pit is provided with a pit cover such that the pit remains covered during the operation, and preferably also remains covered during a translational movement of one or more of the moveable lifting devices.

A vehicle is lifted by the lifting device that engages one of the wheel axles of the vehicle, for example. The moveable lifting devices are positioned relative to the respective wheel axles. Optionally, a vehicle wheel base distance measuring system is used for determining the desired location(s) for the moveable lifting devices. A drive is provided for driving and positioning the moveable lifting devices. An example of such drive is illustrated in the aforementioned WO 2015/108414 A1. This document also discloses embodiments of an optional cover.

The in-ground lifting system according to the invention comprises two or more moveable lifting devices. This provides maximum flexibility for the location of lifting a vehicle and for the dimensions of such vehicle. Optionally, one or more additional stationary lifting devices are also provided in the pit. However, to provide a maximum of flexibility when handling vehicles, in a presently preferred embodiment only moveable lifting devices are applied in the lifting system.

The in-ground lifting system of the invention comprises a system controller that is configured for defining at least one set of lifting devices from the available lifting devices for lifting the vehicle. This enables defining a set of lifting devices for a specific vehicle, typically depending on the number of wheel axles. This system controller provides flexibility in defining sets of lifting devices. For example, in a pit having a length of 35 meters extending over the workshop floor six moveable lifting devices can be provided. The system controller may define a set of lifting devices consisting of two lifting devices for lifting a small vehicle, and more lifting devices in one set for a larger vehicle. The other lifting devices in the pit may be put at rest and/or can be used for other tasks. This contributes to a flexible in-ground lifting system.

Optionally, at a later stage, further lifting devices can be provided to the pit. Also, a moveable lifting device can be relocated from one pit to another pit and be added to another lifting system such that the system controller may select it for a set. This further increases the flexibility of working with the lifting system of the present invention.

The lifting devices can be selected in different ways, for example using a card, RFID, touchscreen, finger print etc. It will be understood that other selecting means can also be envisaged in accordance to the present invention. In a presently preferred embodiment, a user selects the required lifting devices and the control system activates these selected lifting devices as a set, preferably associated with a specific (lifting) job. Then, the set is ready to be used by the user.

In a presently preferred embodiment of the invention, the system controller is configured for defining two or more sets of lifting devices in a single in-ground lifting system. This enables the in-ground lifting system to be used for working on two or more vehicles simultaneously. This enables an efficient use of the space of the workshop floor that is used by the in-ground lifting system. For example, a single large truck, bus or train can be lifted with the in-ground lifting system, or two or more different vehicles can be lifted by the in-ground lifting system simultaneously. It will be understood that the number of vehicles depends on vehicle type and also on the available pit length and number of lifting devices therein. With the effective use of the in-ground lifting system of the invention a pit can be provided over the entire length of the workshop floor, or at least a substantial part thereof. This provides maximum flexibility for lifting one or more vehicles.

Preferably, the system controller of the in-ground lifting system is configured for defining and also controlling the different sets of lifting devices. This controlling enables lifting multiple vehicles simultaneously with the system controller. This provides an efficient in-ground lifting system, wherein the system controller of such system is configured for lifting multiple vehicles. For example, a user that needs lifting a specific vehicle uses the system controller for defining the set of lifting devices that are selected from the available lifting devices of the in-ground lifting system. Then, the system controller enables this specific user to control his or her specific set of lifting devices to do the job. Optionally, the same or another user may select a further set of lifting devices from the available lifting devices to perform another job on another vehicle. This provides an effective use of the workshop floor with the in-ground lifting system of the invention.

In another preferred embodiment of the invention the in-ground lifting system further comprises one or more mobile lifting columns.

Providing the in-ground lifting system with one or more mobile lifting columns achieves additional flexibility. Such additional flexibility may be useful when removing an axle or wheel of the vehicle, for example.

In a presently preferred embodiment the system controller comprises a number of local controllers that are associated to the individual lifting devices. Such local controllers may be attached to the wall and/or to the specific lifting device. The local controllers are optionally used for selecting and/or controlling a single set of lifting devices when lifting a vehicle. Optionally, the local controller is a remote controller or comprises such remote controller to improve flexibility for the user when lifting a vehicle.

In a further preferred embodiment of the invention the system controller comprises a central controller that is configured for controlling multiple sets of lifting devices.

The central controller is preferably connected to one or more of the local controllers for enabling selection of the different sets. Optionally, the central controller is a remote controller or comprises such remote controller. In a presently preferred embodiment of the invention the central controller is also configured for controlling one or more of the additional mobile lifting columns. This provides optimal flexibility for a user when lifting a vehicle.

In a further preferred embodiment of the invention the pit comprises a number of modular pit structures.

The pit of the in-ground lifting system of the invention is preferably provided with a substantial length, more preferably the pit extends over substantially the entire length of the workshop floor. Optionally, the pit can be extended at a later stage preferably using the modular system. In a presently preferred embodiment a pit edge is provided in the (concrete) workshop floor, such that the pit frame can be easily attached to this pit edge. This enables attaching the pit frame to the edge in a more flexible manner such that installing work for the in-ground lifting system of the invention is significantly reduced.

In a further preferred embodiment of the invention the in-ground lifting system further comprises an individual hydraulic unit for each of the individual lifting devices.

Providing an individual lifting device of the in-ground lifting system with an individual hydraulic unit provides optimal flexibility for the in-ground lifting system. For example, this enables extending the in-ground lifting system with additional lifting devices at a later stage without requiring lots of installation work. This is even more advantageous when extending the pit length at a later stage to enable providing additional multiple lifting devices. The hydraulic unit is preferably mounted on or attached to the lifting device, for example attached to a cylinder thereof.

In a further preferred embodiment of the invention the lifting devices comprise an energy system.

Such energy system provides the energy that is required for moving the lifting device and/or lifting a vehicle therewith. In one of the presently preferred embodiments the energy system comprises a regenerative energy system that is configured for charging the energy system when lowering the vehicle. This contributes to an effective use of the energy.

In another presently preferred embodiment the energy system comprises a wireless charging system. Such wireless charging system obviates the use of charging cables in the pit. This wireless charging preferably relates to inductive charging using an electro-magnetic field to transfer energy, thereby enabling charging a battery of the lifting device. Alternatives that can also be used as an alternative to, or in combination with, inductive charging relate to conductive wireless charging that use a conductor to connect to electronic devices for the transfer of energy and charging of the battery. Other possibilities include wireless power transfer using an inductive charging pod as an example of inductive charging. It will be understood that different charging types can also be used in combination effectively, for example a type of inductive charging in combination with regenerative charging. It will also be understood that other possibilities can be used as an alternative or in combination therewith, such as the use of solar energy.

The charging type preferably enables charging in a safe manner, more specifically in a sealed system that is preferably also Atex proof to improve the overall safety in the workshop. In one of the presently preferred embodiments the energy system comprises a continuous charging system that enables charging at every location wherein one of the moveable lifting devices is positioned. This provides an effective possibility of charging such that the moveable lifting device has an optimal availability for the lifting of vehicles.

In a presently preferred embodiment the moveable lifting device comprises a piston type lifting device. This piston type lifting device can be a hydraulic lifting device, a pneumatic lifting device and/or an electric lifting device using a so-called electric cylinder, for example.

Alternatively, or in addition thereto, the moveable lifting device comprises a scissor type lifting device with a similar hydraulic, pneumatic or electric drive.

The in-ground lifting system according to the invention also comprises a cover that is a rolling type or plate type.

The invention further relates to a method for configuring an in-ground lifting system, the method comprising the steps of:
defining the dimensions of the lifting system;
placing two or more moveable lifting devices in the pit; and
providing a system controller configured for defining at least one set of lifting devices for lifting a vehicle.

Such method provides similar advantages and effects as mentioned in relation to the in-ground lifting system. Especially when providing an in-ground lifting system with a modular pit structure the installation work is significantly reduced.

The invention further also relates to a method for lifting a vehicle, comprising the step of providing an in-ground lift according to an embodiment of the invention.

Such method provides similar advantages and effects as mentioned in relation to the in-ground lifting system and/or method for configuring an in-ground lifting system.

### BRIEF DESCRIPTION OF THE DRAWINGS

Further advantages, features and details of the invention will be elucidated on the basis of preferred embodiments thereof, wherein reference is made to the accompanying drawings, in which:

FIG. 1 shows an in-ground lifting system of the invention;

FIG. 2 shows a moveable device of the system illustrated in FIG. 1;

FIG. 3 shows the in-ground lifting system of FIG. 1 wherein two sets of lifting devices are defined; and

FIG. 4 shows a piston type cylinder that can be used as an alternative lifting device in the in-ground lifting system of FIG. 1.

### DESCRIPTION OF THE INVENTION

The following description is merely exemplary in nature and is in no way intended to limit the invention, its application, or uses. While the disclosure is described as having exemplary attributes and applications, the present disclosure can be further modified. This application is therefore intended to cover any variations, users, or annotations of the disclosure using its general principles. Further, this application is intended to cover such departures from the present disclosure as commonly known or customary practice of the skilled in the art to which this disclosure pertains and which fall within the limits of the appended claims. Accordingly, the following description of certain embodiments and examples should be considered merely exemplary and not in any way limiting.

The lifting system of the present invention is suitable for use with lifting systems comprising any number of lifting devices, including without limitation piston and scissor lifts and systems having one, two, four or another number of suitable lifting devices. The lifting devices may achieve lifting and lowering capability by means known to those of skill in the art, including hydraulically, electrically, mechanically, and electromechanically. Lifting systems compatible with the present lifting system may be stationary and/or permanently affixed or attached to a certain location or may be mobile, or capable of being transported. With reference to the figures, alike element numbers refer to the same element between drawings.

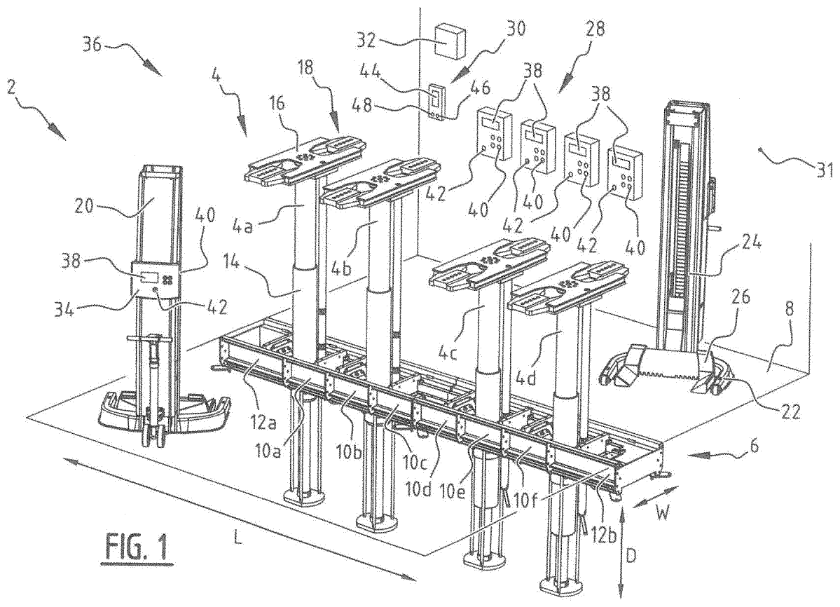

In-ground lifting system 2 (FIG. 1) comprises a number of moveable lifting devices 4. In the illustrated embodiment four moveable lifting devices 4a, b, c, d are provided in pit 6 that is provided in workshop floor 8. Pit 6 comprises a number of modular intermediate pit structures 10a, b, c, d, e, f. End structures 12a, b are provided at the end of pit 6. It will be understood that end structures 12a, b can be similar to the intermediate structures 10a-f. Moveable lifting devices 4 comprise a piston 14 and carrier 16 with axle carriers 18. Pit 6 is provided with length L, depth D, width W.

In the illustrated embodiment lifting system 2 also comprises mobile lifting columns 20 having a foot 22, mast 24 and carrier 26.

In the illustrated embodiment, lifting system 2 is provided with a number of local controllers 28 that are provided at wall 31 and are associated with individual lifting devices 4a-d. Alternatively, local controllers 28 are attached to moveable lifting devices 4a-d and/or are also moveable. In the illustrated embodiment remote control 30 is provided. Optionally, transmitter 32 is located in the workshop to enable wireless communication between the individual components of system 2. Mobile lifting columns 20 can be provided with a separate local controller 34. System controller 36 may comprise one or more of the local controllers 28, 34 and/or may optionally comprise remote controller 30 and/or may use transmitter 32 that can also act as a central control unit with a remote input device such as remote controller 30. Optionally, an individual local controller 28, 34 can be used as a master or central controller. It will be understood that different control configurations can be applied in system 2 of the invention. Local controllers 28, 34 comprise a display 38 and a number of buttons 40. Also, in the illustrated embodiment identification device 42 is provided enabling a user to identify himself or herself to the system controller 36 that may comprise one or more of the control components 28, 30, 32, 34. Also remote control 30 can be provided with display 44, button 46 and identification means 48. It will be understood that identification means 48 may also use button(s) 46 for entry of a pin-code and/or display 38, 44 for fingerprint scanning or other appropriate manners, for example.

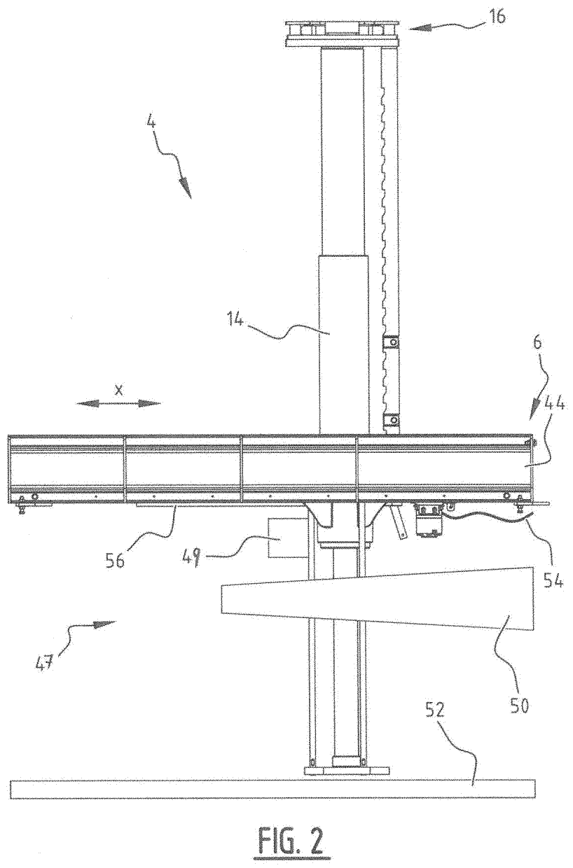

Moveable lifting device 4 (FIG. 2) comprises piston 14 and carrier 16. Device 4 is provided in frame 44 of pit 6 and moves in direction x along pit 6. In the illustrated embodiment energy system 47 comprises regenerative energy system 49 that regenerates energy when lowering carrier 16. This may involve redirecting the hydraulic fluid in a regeneration loop. Energy system 47 may also comprise inductive charging system 50 (schematically illustrated in FIG. 2). As an alternative, or in addition thereto, charging plate 52 is provided in the bottom of pit 6. Other charging means may comprise charging cable 54 and/or wireless conductive charging system 56.

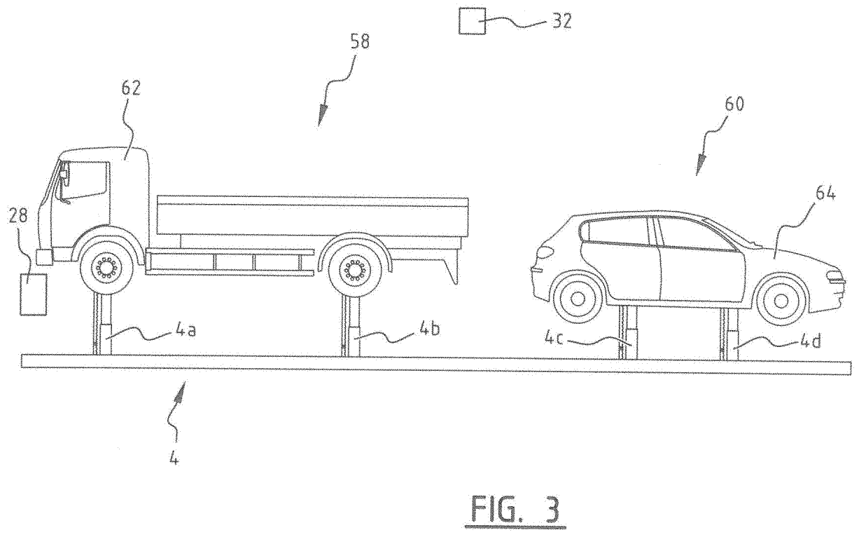

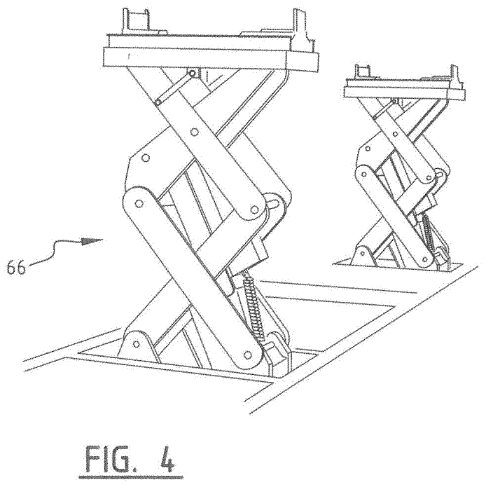

In-ground lifting system 2 may comprise multiple sets of lifting devices 4 (FIG. 3). First set 58 comprises moveable lifting devices 4a, b and second set 60 comprises moveable lifting device 4c, d for respectively lifting truck 62 and passenger car 64. It will be understood that another number of sets 58, 60 and/or different types of vehicles 62, 64 can also be provided. Furthermore, it will be understood that an individual set 58, 60 may comprises any number of lifting devices 4, including mobile lifting columns 20. An individual set can be controlled with local controller 38 optionally using central transmitter 32. Although moveable lifting devices 4 are illustrated as piston-type lifting devices 4, it will be understood that as an alternative also scissor type lifting devices 66 can be used (FIG. 4).

When lifting a vehicle 58, 60 a user first positions vehicle 58, 60 over pit 6. Next, moveable lifting devices 4, optionally with additional mobile columns 20, are positioned correctly. A user identifies himself with identification device 42 and/or another suitable system. The appropriated lifting devices 4, 20 are selected for an individual vehicle 58, 60 to define lifting set 58, 60. The lifting operation can be controlled with a local controller 28, 34 and/or remote controller 30 and/or another appropriate controller. Remaining lifting devices 4, 20 that are not used in selection 58, 60 remain available for a further set that can be defined by the same or another user working with the same lifting system 2.

When installing lifting system 2 a hole suitable for receiving pit 6 is provided in workshop floor 8. Pit structures 10, 12 are provided in the hole to define pit 6. Thereafter the individual moveable lifting devices 4 are positioned in pit 6. Optionally, one or more stationary lifting devices can also be provided in pit 6. However, in a presently preferred embodiment of the invention the use of moveable lifting devices is preferred. Control system 36 is provided to enable selecting and controlling the lifting devices. Energy system 47 is provided to enable charging of the moveable lifting devices. Thereafter a user may operate the lifting devices for lifting operations of one or more vehicles 58, 60.

The present invention is by no means limited to the above described preferred embodiments thereof. The rights sought are defined by the following claims, wherein the scope of which many modifications can be envisaged. For example, it is explicitly mentioned that combinations of the illustrated embodiments, including combination of individual features thereof, are possible.

1. An in-ground lifting system for lifting a vehicle, the lifting system comprising:
a pit provided with a pit frame;
two or more moveable lifting devices configured for moving in the pit; and
a system controller configured for defining at least one set of lifting devices from available lifting devices for lifting a vehicle.

2. The in-ground lifting system according to claim 1, wherein the system controller is configured for defining two or more sets of lifting devices.

3. The in-ground lifting system according to claim 2, wherein the system controller is configured for lifting multiple vehicles.

4. The in-ground lifting system according to claim 1, further comprising one or more mobile lifting columns.

5. The in-ground lifting system according to claim 1, wherein the system controller comprises a number of local controllers that are associated to the individual lifting devices.

6. The in-ground lifting system according to claim 1, wherein the system controller comprises a central controller that is configured for controlling multiple sets of lifting devices.

7. The in-ground lifting system according to claim 1, wherein the pit comprises a number of modular pit structures.

8. The in-ground lifting system according to claim 1, wherein the individual lifting devices comprise an individual hydraulic unit.

9. The in-ground lifting system according to claim 1, wherein the lifting devices comprise an energy system.

10. The in-ground lifting system according to claim 9, wherein the energy system comprises a regenerative energy system configured for charging the energy system when lowering the vehicle.

11. The in-ground lifting system according to claim 9, wherein the energy system comprises a wireless charging system.

12. The in-ground lifting system according to claim 9, wherein the energy system comprises a continuous charging system.

13. The in-ground lifting system according to claim 1, wherein the moveable lifting device comprises a piston type lifting device.

14. The in-ground lifting system according to claim 1, wherein the moveable lifting device comprises a scissor type lifting device.

15. The in-ground lifting system according to claim 1, further comprising a cover.

16. The in-ground lifting system according to claim 10, wherein the energy system comprises a wireless charging system.

17. An in-ground lifting system for lifting a vehicle, the lifting system comprising:
a pit provided with a pit frame;
two or more moveable lifting devices configured for moving in the pit; and
a system controller configured for defining at least one set of lifting devices from available lifting devices for lifting a vehicle,
wherein the system controller is configured for defining two or more sets of lifting devices, wherein the system controller comprises a number of local controllers that are associated to the individual lifting devices, and wherein the system controller comprises a central controller that is configured for controlling multiple sets of lifting devices.

18. An in-ground lifting system for lifting a vehicle, the lifting system comprising:
a pit provided with a pit frame;
two or more moveable lifting devices configured for moving in the pit; and
a system controller configured for defining at least one set of lifting devices from available lifting devices for lifting a vehicle,
wherein the lifting devices comprise an energy system, and wherein the energy system comprises a regenerative energy system configured for charging the energy system when lowering the vehicle.

19. A method for configuring an in-ground lifting system, the method comprising the steps of:
defining the dimensions of the lifting system;
placing two or more moveable lifting devices in the pit; and
providing a system controller configured for defining at least one set of lifting devices from available lifting devices for lifting a vehicle.

20. A method for lifting a vehicle, comprising the step of providing an in-ground lift according to in-ground lifting system for lifting a vehicle, the lifting system comprising:
a pit provided with a pit frame;
two or more moveable lifting devices configured for moving in the pit; and
a system controller configured for defining at least one set of lifting devices from available lifting devices for lifting a vehicle.
